(19) United States
(12) Patent Application Publication
(10) Pub. No.: US 2022/0389236 A1
(43) Pub. Date: Dec. 8, 2022

(54) Primer Composition and Methods

(71) Applicant: 3M INNOVATIVE PROPERTIES COMPANY, St. Paul, MN (US)

(72) Inventor: Lianzhou Chen, Woodbury, MN (US)

(21) Appl. No.: 17/776,187

(22) PCT Filed: Nov. 20, 2020
(86) PCT No.: PCT/IB2020/060537

§ 371 Date: May 11, 2022

Related U.S. Application Data
(60) Provisional application No. 62/936,088, filed on Nov. 15, 2019.

(51) Int. Cl. C09D 5/08; C09D 7/20; C09D 7/61; C09D 7/65; C09D 7/40; C09D 183/06; C09D 163/00

(52) U.S. Cl. CPC C09D 5/084; C09D 7/20; C09D 7/61; C09D 7/65; C09D 7/69; C09D 7/68; C09D 183/06; C09D 163/00

(57) ABSTRACT

A one-part primer composition is provided. The one-part primer composition includes a first epoxy resin that is a liquid under ambient conditions a particulate corrosion inhibitor present in an amount of from 5 wt % to 30 wt % relative to the overall weight of the composition excluding carrier solvents and water, a curative comprising a primary aromatic amine, a silane coupling agent, a carrier solvent; and water homogeneously mixed with the carrier solvent and present in an amount sufficient to hydrolyze the silane coupling agent while preserving solubility of the first epoxy resin and curative in the carrier solvent/water mixture. The corrosion inhibitor is pre-dispersed in a liquid epoxy to break the agglomeration of the inhibitors, mitigate settling of the pigment and improve primer performance.

### FIELD OF THE INVENTION

Provided are primer compositions for protecting substrates from corrosion. Substrates that can be protected by these primer compositions include primary and secondary aircraft structures.

### BACKGROUND

Corrosion protection of primary and secondary structures of aircraft and development of improved environmentally friendly corrosion protection products for aluminum aerospace alloys are critical issues to aircraft manufacturers. Corrosion can be mitigated or avoided altogether by applying a primer onto metallic surfaces that functions as a barrier layer on vulnerable structures. For added protection, it is possible to add corrosion inhibitors to such primers.

Conventional corrosion inhibitors for aluminum alloys contain hexavalent-chromium compounds, which are used in both surface preparation and organic primer compositions. These chromium compounds generally include chromates, which are salts with an anion containing chromium and oxygen, such as CrO₄²⁻. These primers protect the underlying substrate and promote adhesion to various adhesives, including structural adhesives, which are later bonded to the substrate. Yet, the toxicity and carcinogenic properties of chromium have caused regulatory agencies to impose restrictions on its use.

Various non-chromated pretreatments and primers have been developed and tested over the past several years in response to these toxicity concerns. Water-based primers free of chromium compounds have been developed to address many of these shortcomings. However, because of the higher flash point of the water based primer, these primers have difficulty in meeting the high throughput production requirements, especially those encountered in the automated spraying processes used by major aircraft manufacturers.

### SUMMARY

Many of the chromated solvent based epoxy bonding primer on the market are based on high molecular weight phenoxy resins blended with other small molecular weight epoxy and phenolic resins, with urea-based accelerators. The higher molecular weight of the phenoxy type epoxy can help stabilize the corrosion inhibitor. Non-chromated inhibitors tend be less effective than chromate-based inhibitors, and can be compensated for by increasing the crosslink functionality. This, in turn, usually involves the use of lower molecular weight resins, which have lower viscosity.

The viscosity issue can be problematic because the corrosion inhibitors are particulate, and they tend to settle during storage and use. Settling can result in poor uniform coating quality as well as variability in primer performance and is undesirable. To alleviate this settling issue, surfactants can be added, but these surfactants can negatively impact primer performance, because they make water penetration easier through the primer when cured.

There is a need for a system that manages the settling of the inhibitor pigment in a lower viscosity solvent primer system and requires little or no surfactants. The provided primer compositions meet this requirement by using smaller particle sizes of the inhibitor pigments and by pre-dispersing the particles in a high viscosity epoxy resin. By pre-dispersing the particulate corrosion inhibitor in the epoxy resin it is possible to 1) break the agglomeration of the inhibitors, 2) mitigate settling of the pigment and 3) improve homogeneity, thereby improving bond reliability on the cured primer.

In a first aspect, a one-part primer composition is provided. The one-part primer composition comprises: a first epoxy resin that is a liquid under ambient conditions; a particulate corrosion inhibitor present in an amount of from 5 wt % to 30 wt % relative to the overall weight of the composition excluding carrier solvents and water, wherein the particulate corrosion inhibitor has a median primary particle size of from 0.5 micrometers to 10 micrometers; a curative comprising a primary aromatic amine; a silane coupling agent; a carrier solvent; and water homogeneously mixed with the carrier solvent and present in an amount sufficient to hydrolyze the silane coupling agent while preserving solubility of the first epoxy resin and curative in the carrier solvent/water mixture. Optionally, the primer composition further contains one or more co-curatives or catalysts that facilitate curing of the primer.

In a second aspect, a method of making a one-part primer composition is provided, the method comprising the steps of: dispersing a particulate corrosion inhibitor in a first epoxy resin having a viscosity of from 50 centipoise to 1,000,000 centipoise under ambient conditions to provide a particulate dispersion; mixing the particulate dispersion with a silane coupling agent, an amount of water sufficient to hydrolyze the silane coupling agent, a curative comprising a primary aromatic amine, and at least one non-water carrier solvent.

### Definitions

As used herein:

“ambient conditions” means at a temperature of 25 degrees Celsius (° C.) and a pressure of 1 atmosphere (i.e., 101.3 kPa);

“ambient temperature” refers to a temperature of 25° C.;

“average” refers to a number average by default, unless otherwise specified;

“cure” refers to chemically crosslinking, such as by exposing to radiation in any form, heating, or allowing to undergo a chemical reaction that results in hardening or an increase in viscosity (e.g., under room temperature or heated conditions);

“polymeric” refers to a molecule having a plurality of repeating units;

“soluble” means able to fully dissolve in a given liquid;

“solvent” refers to a liquid, such as a silicone, organic compound, water, alcohol, ionic liquid, or supercritical fluid, that is capable of dissolving a solid, liquid, or gas, and that is ultimately removed from a composition in end use;

“substantially” refers to a majority of, or mostly, as in an amount of at least 50%, 60, 70, 80, 90, 95, 96, 97, 98, 99, 99.5, 99.9, 99.99, or 99.999%, or 100% of a composition based on weight or volume;

“substantially free of” means having a trivial amount of, such that a composition is 0 wt % to 5 wt % of a given component, or 0 wt % to 1 wt %, or 5 wt % or less than, equal to, or greater than 4.5 wt %, 4, 3.5, 3, 2.5, 2, 1.5, 1, 0.9, 0.8, 0.7, 0.6, 0.5, 0.4, 0.3, 0.2, 0.1, 0.01, or 0.001 wt %, or 0 wt % of the component; and

“substituted” refers to the state in which one or more hydrogen atoms contained therein are replaced by one or more non-hydrogen atoms.

### DETAILED DESCRIPTION

As used herein, the terms “preferred” and “preferably” refer to embodiments described herein that can afford certain benefits, under certain circumstances. However, other embodiments may also be preferred, under the same or other circumstances. Furthermore, recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

The primer compositions described herein can be used to protect a surface against corrosion, promote adhesion, and enhance bond durability in operating conditions. In aerospace applications, such operating conditions include exposure to salt, moisture and wide thermal fluctuations.

The primer compositions can be disposed onto any of a number of possible substrates. Substrates commonly encountered in the aircraft industry include aluminum, aluminum cladding, titanium, and fiber-reinforced composites. The range of potential substrates, however, need not be so limited. In alternative applications, for example, the primer compositions can be applied to painted substrates, thermoplastic substrates, electroplated metal substrates, and metal substrates in general.

In aircraft applications, temperatures can reach less than −40° C., making low-temperature performance extremely important for a primer.

The provided primer compositions include at least one epoxy resin. A given epoxy resin used in the composition may be either liquid or solid under ambient conditions. In preferred embodiments, the primer composition includes a mixture of two or more of the aforementioned resins. The two or more epoxy resins may be a combination of solid and liquid epoxy resins. Where two or more epoxy resins are present, the resins can be homogeneously mixed by dissolving them in a common solvent or solvent mixture within the primer composition.

Suitable epoxy resins include conventional epoxy resins having an average functionality of at least 1.5, 1.6, 1.7, 1.8, 1.9, 2, 2.1, 2.2, 2.2, 2.4, 2.5, 2.7, 3, 3.5, 4, or in some cases greater than 4. In some embodiments, the epoxy resin can be substantially free of ionic or ester groups. Epoxy resins can be chain-extended, glycidyl ethers of phenols, such as resorcinol and the bisphenols, e.g., bisphenol A and bisphenol F. Other useful epoxy resins are solid novolac epoxy resins and epoxy resins derived from a liquid epoxy resin and bisphenol-A resins. Novolac epoxy resins are made by acid-catalyzed addition oligomerization of phenol with formaldehyde, and subsequently modified with epichlorohydrin to provide the resin with epoxy functionalities.

The epoxy resin can include one or more aliphatic glycidyl ethers. These include cresylglycidyl ether; alkyl glycidyl ether; 2-ethylhexyl glycidyl ether; 1,4-butanediol diglycidyl ether; 1.6-hexanediol diglycidyl ether; 1.4-cyclohexanedimethanol diglycidyl ether; monoglycidyl, diglycidyl, and polyglycidyl variants thereof; and mixtures of the foregoing. Exemplary aliphatic diglycidyl ethers are commercially available and have been sold under the trade designation DER 732, having an epoxy equivalent weight of approximately 320 g/eq, or DER 736, having an epoxy equivalent weight of approximately 190 g/eq, both from Dow Inc., Midland, Mich.

Other commercially available epoxy resins include EPON SU-8, a polymeric epoxy resin with an average functionality of 8, melting point of 82° C., and an epoxy equivalent weight of 215 g/eq, from Hexion, Inc., Columbus, Ohio; DER 669, a high molecular weight solid epoxy resin having a softening point of 135-155° C. and an epoxy equivalent weight of 3500-5500 g/eq from Dow Inc., Midland, Mich.; EPON 1002, a solid BPA epoxy having an epoxy equivalent weight of 550-650 g/eq and a melting point of from 75-85° C., also from Hexion, Inc., Columbus, Ohio; and ARALDITE ECN 1273, 1280, and 1299 novolac solid epoxy resins having epoxy functionalities from 3.8 to 5.4, epoxy equivalent weights of from 225-235 g/eq, and melting points of from 73-99° C., from Huntsman Corporation, The Woodlands, Tex.

In some embodiments, the epoxy resin contains a glycidoxy amine or aminophenol, such as N,N,N′,N′-tetrakis(glycidyl)-4,4-diaminodiphenyl methane or N,N,O-tris(glycidyl)-4-aminophenol. Alternatively, the epoxy resin can be based on glycidyl ethers of various dihydroxy-naphthalenes and phenolated dicyclopentadienes.

Many of these foregoing epoxy resins, and other suitable epoxy resins, are disclosed in the treatise Handbook of Epoxy Resins, McGraw-Hill, Inc., 1967, which is herein incorporated by reference.

The liquid epoxy resin or resins can be present in an amount of from 5 percent to 40 percent, from 10 percent to 30 percent, from 10 percent to 25 percent, or in some embodiments, less than, equal to, or greater than 5 percent, 6, 7, 8, 9, 10, 12, 15, 17, 20, 22, 25, 27, 30, 32, 35, 37, or 40 percent, relative to the overall weight of the primer composition excluding carrier solvents and water.

The solid epoxy resin or resins can be present in an amount of from 1 percent to 30 percent, from 2 percent to 20 percent, from 2 percent to 10 percent, or in some embodiments, less than, equal to, or greater than 1 percent, 2, 3, 4, 5, 6, 7, 8, 9, 10, 12, 15, 17, 20, 22, 25, 27, or 30 percent, relative to the overall weight of the primer composition excluding carrier solvents and water.

In some embodiments, the primer composition includes two or more solid epoxy resins, at least one of which is a bisphenol A extended solid epoxy resin (sometimes called a bisphenol A-based solid epoxy). The bisphenol A extended solid epoxy resin can be present in an amount of from 15 percent to 75 percent, from 25 percent to 60 percent, from 35 percent to 60 percent, or in some embodiments, less than, equal to, or greater than 15 percent, 20, 25, 30, 35, 40, 45, 50, 55, 60, 65, 70, or 75 percent, relative to the overall weight of the primer composition excluding carrier solvents and water.

Generally, the epoxy resin components and curatives in the provided primer composition are homogeneously dissolved in a common solvent known as a carrier solvent. This carrier solvent is a volatile, non-water solvent that may form an azeotrope with water and assist in the film-forming process by accelerating the collective evaporation of the solvents after the primer composition is applied to a substrate.

Suitable carrier solvents can include any solvent miscible with a sufficient quantity or volume of water. In some instances, the carrier solvent will dissolve the thermosetting resins. Some carrier solvents, or mixtures thereof, have a flash point below ambient temperature. In some embodiments, the flash point of the carrier solvent, or carrier solvent mixture, can be up to −20° C., −15° C., −10° C., −5° C., 0° C., 5° C., 10° C., 15° C., or 20° C. at ambient pressure. The carrier solvents can include one or more of tetrahydrofuran, diacetone alcohol, a glycol monoether, methyl alcohol, ethyl alcohol, isopropyl alcohol, acetone, methyl ether ketone, methyl propyl ketone, methyl isopropyl ketone, and methyl isobutyl ketone.

The carrier solvent can be present in an amount of from 30 wt % to 95 wt %, from 30 wt % to 90 wt %, from 60 wt % to 90 wt %, or in some embodiments, less than, equal to, or greater than 30 wt %, 35, 40, 45, 50, 55, 60, 65, 70, 75, 80, 85, 90, or 95 wt %, based on the overall weight of the primer composition.

One or more particulate corrosion inhibitors can be present in the primer composition. As mentioned previously, the one or more corrosion inhibitors are generally insoluble with the remaining components in the primer composition, and can be advantageously pre-dispersed in a liquid epoxy resin to prevent agglomeration of these particulate components.

Corrosion inhibitors are active chemical compounds that can be added to the primer composition to decrease the corrosion rate of the substrate on which the primer is applied. Corrosion is a persistent problem in many applications, and particularly aerospace applications in which aircraft surfaces can be exposed to humid environments, acid rain, and thermal cycling, conditions which tend to facilitate corrosion. Useful corrosion inhibitors can be a chromate-based corrosion inhibitor or, alternatively, a non-chromate corrosion inhibitor substantially free of chromium and chromium compounds.

Chromate-based corrosion inhibitors include strontium chromate, barium chromate, zinc chromate, and calcium chromate, and mixtures thereof. Non-chromate corrosion inhibitors include strontium aluminum polyphosphate hydrate, calcium phosphate, calcium aluminum polyphosphate silicate hydrate, zinc phosphate, zinc molybdate, and zinc aluminum polyphosphate hydrate, and mixtures thereof. Preferably, the provided primer compositions are substantially or entirely free of hexavalent chromium and chromium compounds.

Corrosion inhibitors are generally provided in the primer composition as particulate solids having a median primary particle size (D50) of from 0.1 micrometers to 100 micrometers, from 0.2 micrometers to 50 micrometers, from 0.3 micrometers to 10 micrometers, or in some embodiments, less than, equal to, or greater than 0.1 micrometers, 0.2, 0.3, 0.4, 0.5, 0.7, 1, 2, 3, 4, 5, 7, 10, 12, 15, 17, 20, 25, 30, 35, 40, 45, 50, 60, 70, 80, 90, or 100 micrometers.

The concentration of corrosion inhibitors is preferably effective to significantly reduce corrosion rate but not to the extent that ease of application, film forming ability or surface finish is unduly complicated or compromised. The corrosion inhibitor can be present in an amount of from 5 wt % to 30 wt %, from 7 wt % to 25 wt %, from 10 wt % to 20 wt %, or in some embodiments, less than, equal to, or greater than 0.1 wt %, 0.2, 0.5, 0.7, 1, 1.5, 2, 2.5, 3, 4, 5, 6, 7, 8, 9, 10, 12, 15, 17, 20, 22, 25, 26, 27, 28, 29, or 30 wt %, based on the overall weight of the primer composition excluding water and volatile carrier solvents.

The particulate corrosion inhibitors remain as insoluble species in the primer composition and tend to settle over time with gravity. Advantageously, the liquid epoxy resin or resins can be used as a medium to pre-disperse these corrosion inhibitors prior to mixing these components with the solvent components. As a result, agglomeration of these corrosion inhibitors can be substantially reduced, resulting in finer particles, smoother coatings, and improved primer stability.

To achieve a stable dispersion with the corrosion inhibitors, the liquid epoxy resin alone can have a viscosity of from 50 centipoise to 1,000,000 centipoise, from 50 centipoise to 100,000 centipoise, from 100 centipoise to 10,000 centipoise, or in some embodiments, less than, equal to, or greater than 50 centipoise; 60; 70; 80; 90; 100; 110; 120; 150; 200; 300; 400; 500; 700; 1000; 2000; 5000; 10,000; 15,000; 20,000; 50,000; 70,000; 100,000; 200,000; 500,000; 700,000; or 1,000,000 centipoise under ambient conditions.

The primer composition can further include one or more adhesion promoters to enhance bonding to metal substrates. Suitable adhesion promoters include epoxy silanes. Useful epoxy silanes have the formula:

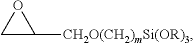

wherein m ranges from 1 to 6, and each R is H or an alkyl group of 1 to 10 carbon atoms. In an alternative embodiment, the epoxy silane can have the formula:

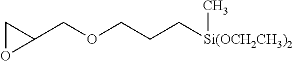

A sufficient amount of water is included to hydrolyze the silane coupling agent and enable facile covalent bonding to the metal oxide substrates, including for example aluminum oxide surfaces found on aluminum components. It is desirable, however, for the amount of water to be limited to amounts that preserve the full solubility of the epoxy resin and curative components in the carrier solvent/water mixture. For certain epoxy resins and curatives, an excessive amount of water in the primer composition can induce saturation and precipitate resins and/or curatives out of solution, which is not desirable.

Mindful of the aforementioned considerations, water can be present in an amount of from 0.1 wt % to 20 wt %, 0.5 wt % to 10 wt %, 1 wt % to 5 wt %, or in some embodiments, less than, equal to, or greater than 0.1, 0.2, 0.5, 0.7, 1, 2, 5, 7, 10, 12, 15, 17, or 20 wt %, relative to the overall weight of the primer composition.

The primer composition can further include one or more inorganic fillers. The addition of inorganic fillers can help prevent sagging during the process of curing the primer composition. An exemplary inorganic filler is fumed silica, which can be used as thickening agent purposefully increasing the viscosity of the primer composition when it is applied to the surface of the substrate to be protected.

A given inorganic filler can be present in an amount of from 0.01 wt % to 15 wt %, from 0.5 wt % to 10 wt %, from 1 wt % to 5 wt %, or in some embodiments, less than, equal to, or more than 0.01 wt %, 0.02, 0.03, 0.04, 0.05, 0.07, 0.08, 0.09, 0.1, 0.2, 0.3, 0.4, 0.5, 0.7, 1, 1.5, 2, 2.5, 3, 4, 5, 6, 7, 8, 9, 10, 11, 12, 13, 14, 15, 16, 17, 18, 19, or 20 wt %, based on the overall weight of the primer composition excluding carrier solvents and water.

The provided compositions further contain a curative, or two or more curatives acting together, to cure or crosslink the epoxy resins under the desired curing conditions, typically at primer bake temperatures. The curative may be comprised of two more components, each of which may be either a solid or liquid under ambient conditions. For easy handling, it is preferable that the curative is soluble in the solvent or solvent mixture in the primer composition.

Suitable curatives include aromatic amines and mixtures thereof. Exemplary aromatic amines include 4,4′-diaminodiphenylmethane, 2,2-bis(4-[4-aminophenoxy]phenyl)propane, 3,3′- and 4,4′-diaminodiphenylsulfone, 3,3′- and 4,4′-diaminodiphenyloxide, 3,3- and 4,4′-diaminodiphenyloxide, 3,31′- and 4,4′-diaminodiphenylsulfide, 3,3′- and 4,4′-diaminodiphenylketone, and 4,4′-[1,4-phenylene(1-methylethylidene)]-bis(benzeneamine).

Solid diamine curatives include 2,4-toluenediamine, 1,4- phenylenediamine, 2,2-bis(4-aminophenyl)hexafluoro propane, 2,2-bis(3-amino-4-hydroxyphenyl)hexafluoro propane, 3,4′-diaminodiphenyloxide, 9,9-bis(4-aminophenyl)fluorene, o-toluidine sulfone, and 4,4′-diaminobenzanilide. Preferred curatives include 9,10-bis(4-aminophenyl) anthracene, 2,2-bis(4-[3-aminophenoxy]phenyl)sulfone, 2,2-bis(4-[4-aminophenoxy]phenyl)sulfone, 1,4-bis(4-aminophenoxy)biphenyl, bis(4-[4-aminophenoxy)phenyl) ether, and 2,2-bis([4-(4-amino-2-trifluorophenoxy)]phenyl)hexafluoropropane.

Preferred aromatic amine curatives include 2,2-bis-[4-(4-aminophenoxy)-phenyl]propane (BAPP), 2,2′-diaminodiphenyl sulfone, 4,4′-diaminodiphenyl sulfone, and mixtures thereof. Particular options and advantages concerning the foregoing curatives can be found in U.S. Pat. Nos. 5,641,818 (Sweet) and 6,475,621 (Kohli et al.).

Optionally, the primer composition further contains one or more co-curatives or catalysts that facilitate curing of the primer. Suitable curatives include substituted amino triazines (examples of which are commercially available under the trade designation CUREZOL from Evonik Industries AG in Essen, Germany), any of the modified aliphatic and cycloaliphatic amines provided under the trade designation ANCAMINE from Evonik Industries AG in Essen, Germany, dicyandiamide, including micronized grades available under the trade designation AMICURE from Evonik Industries AG in Essen, Germany, bisurea-based curing agents, such as toluene-2,4-bis(N,N′ dimethyl urea) (available under the trade designation OMICURE from Emerald Performance Materials LLC in Vancouver, Wash.), and water-insoluble amine-epoxy adducts.

The curatives, individually or collectively, can be present in an amount of from 0.5 wt % to 40 wt %, from 5 wt % to 30 wt %, from 10 wt % to 20 wt %, or in some embodiments, less than, equal to, or more than 0.5%, 0.6, 0.7, 0.8, 0.9, 1, 1.5, 2, 2.5, 3, 4, 5, 6, 7, 8, 9, 10, 12, 15, 17, 20, 22, 25, 26, 27, 28, 29, 30, 31, 32, 33, 34, 35, 36, 37, 38, 39, or 40%, based on the overall weight of the primer composition excluding carrier solvents and water.

The primer composition may further contain any number of dyes, pigments, fillers, leveling agents, additional dispersing agents, and/or thickeners known in the art.

The provided primer compositions can be made by first dispersing the particulate corrosion inhibitors in one or more liquid epoxy resins within an appropriate viscosity range, as characterized previously. At this stage, it can be advantageous to further reduce the median aggregated particle size of the corrosion inhibitors to their final size distribution by further processing the dispersion. Suitable processing steps can include, for example, high-speed shearing, bead milling and sonication methods to break up aggregates of the corrosion inhibitors.

The particulate dispersion can then be mixed with the remaining components of the primer composition. Of these remaining components, the water and carrier solvent can be homogeneously mixed and the first epoxy resin, curative, and any other epoxy resins present in the composition dissolved in the carrier solvent/water mixture.

The provided primer compositions can be coated onto a given substrate using any known method, including spraying, brushing, roller coating, or dip coating. In aerospace applications, it is common for primers to be applied via spray coating. The provided primer compositions are suitable to be sprayed using any of the air driven or airless spray guns, such as high-volume low-pressure spray guns, known in the art.

After the primer composition has been applied to the substrate, the composition is then partially or fully dried. This step removes most of the water and other volatiles from the composition and can occur at ambient or near ambient conditions, without need for external heating. At ambient temperature, the drying time can be from 5 minutes to 300 minutes, from 10 minutes to 100 minutes, from 20 minutes to 50 minutes, or in some embodiments, less than, equal to, or greater than 10 minutes, 15, 20, 25, 30, 35, 40, 45, 50, 60, 70, 80, 90, 100, 110, 120, 150, 200, 250, or 300 minutes.

The dried or partially dried coating can be heated to cure the primer composition. In the curing process, the first and second thermosetting resins react with the curative and each other to form a crosslinked network. Curing temperatures can be from 60° C. to 200° C., from 100° C. to 180° C., from 120° C. to 180° C., or in some embodiments, less than, equal to, or greater than 60° C., 65, 70, 75, 80, 85, 90, 95, 100, 110, 120, 130, 140, 150, 160, 170, 180, 190, or 200° C.

The coated substrate can be sustained at curing temperatures for any sufficient amount of time to achieve an acceptable level of cure. This level of cure can vary based on the application but is generally in the range of from 0.1 hours to 6 hours, 0.5 hours to 2 hours, 0.7 hours to 2 hours, or in some embodiments, less than, equal to, or greater than 0.1 hours, 0.2, 0.3, 0.4, 0.5, 0.6, 0.7, 0.8, 0.9, 1, 1.1, 1.2, 1.5, 2, 2.5, 3, 3.5, 4, 4.5, 5, 5.5, or 6 hours at suitable curing temperatures.

Once cured, the primer coating can have any suitable thickness. These thicknesses can range from 1 micrometer to 20 micrometers, 2 micrometers to 10 micrometers, 3 micrometers to 8 micrometers, or in some embodiments, are less than, equal to, or greater than 1 micrometer, 2, 3, 4, 5, 6, 7, 8, 9, 10, 11, 12, 13, 14, 15, 16, 17, 18, 19, or 20 micrometers.

Once the primer has been applied to a substrate, such as a metal adherend, a second adherend, such as a second metal substrate or a composite substrate, can be adhered to the so-primed substrate in a normal manner by positioning a thermosettable adhesive, such as a structural adhesive, between the primed surface of the substrate and the second adherend, then applying heat and pressure such as to cure the adhesive. Use of such adhesives for a particular application, along with their suitability for such applications and associated curing conditions, are well known to those of ordinary skill.

Further exemplary embodiments, not intended to be exhaustive, are provided as follows:

1. A one-part primer composition comprising: a first epoxy resin that is a liquid under ambient conditions; a particulate corrosion inhibitor present in an amount of from 5 wt % to 30 wt % relative to the overall weight of the composition excluding carrier solvents and water, wherein the particulate corrosion inhibitor has a median primary particle size of from 0.5 micrometers to 10 micrometers; a curative comprising a primary aromatic amine; a silane coupling agent; a carrier solvent; and water homogeneously mixed with the carrier solvent and present in an amount sufficient to hydrolyze the silane coupling agent while preserving solubility of the first epoxy resin and curative in the carrier solvent/water mixture.

2. The composition of embodiment 1, wherein the carrier solvent comprises one or more of tetrahydrofuran, methyl ethyl ketone, diacetone alcohol, and a glycol monoether.

3. The composition embodiments 1 or 2, wherein the first epoxy resin comprises a diglycidyl ether of bisphenol A, bisphenol F, or bisphenol S; a phenolic or cresolic novolac resin; N,N,N′, N′-tetrakis(glycidyl)-4,4-diaminodiphenyl methane; N,N,O-tris(glycidyl)-4-aminophenol; glycidylether of dihydroxy-naphthalene or phenolated dicyclopentadiene; aliphatic diglycidyl ethers or blends of two or more low viscosity aliphatic glycidyl or diglycidyl ethers.

4. The composition of any one of embodiments 1-3, wherein the particulate corrosion inhibitor comprises one or more of: strontium aluminum polyphosphate hydrate, zinc phosphate, zinc molybdate, and zinc aluminum polyphosphate hydrate, calcium phosphate and calcium aluminum polyphosphate silicate hydrate.

5. The composition of any one of embodiments 1-4, wherein the particulate corrosion inhibitor has a median primary particle size of from 0.1 micrometers to 100 micrometers.

6. The composition of any one of embodiments 1-5, further comprising a second epoxy resin that is a solid under ambient conditions, the second epoxy resin comprises a novolac epoxy resin.

7. The composition of embodiment 6, wherein the second epoxy resin is present in an amount of from 1 wt % to 30 wt % relative to the overall weight of the composition excluding carrier solvents and water. 8. The composition of any one of embodiments 1-7, further comprising a third epoxy resin that is a solid under ambient conditions, the third epoxy resin comprising a bisphenol A extended solid epoxy resin.

9. The composition of embodiment 8, wherein the third epoxy resin is present in an amount of from 15 wt % to 75 wt % relative to the overall weight of the composition excluding carrier solvents and water.

10. The composition of any one of embodiments 1-9, wherein the primary aromatic amine comprises one or more of 4,4′-diaminodiphenylmethane, 2,2-bis(4-[4-aminophenoxy]phenyl)propane, 3,3′- and 4,4′-diaminodiphenylsulfone, 3,3′- and 4,4′- diaminodiphenyloxide, 3,3- and 4,4′-diaminodiphenyloxide, 3,3′- and 4,4′-diaminodiphenylsulfide, 3,3′- and 4,4′-diaminodiphenylketone, and 4,4′-[1,4-phenylene(1-methylethylidene)]-bis(benzeneamine).

11. The composition of any one of embodiments 1-10, wherein the water is present in an amount of from 0.1 wt % to 20 wt % relative to the overall weight of the composition.

12. The composition of any one of embodiments 1-11, wherein the silane coupling agent comprises an epoxy silane having either the formula:

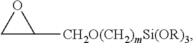

wherein m ranges from 1 to 6, and each R is H or an alkyl group of 1 to 10 carbon atoms, or the formula:

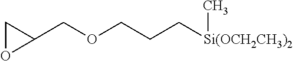

13. The composition of any one of embodiments 1-12, wherein the epoxy resin has a viscosity of from 50 centipoise to 1,000,000 centipoise under ambient conditions. 14. A method of making a one-part primer composition, the method comprising the steps of: dispersing a particulate corrosion inhibitor in a first epoxy resin having a viscosity of from 50 centipoise to 1,000,000 centipoise under ambient conditions to provide a particulate dispersion; mixing the particulate dispersion with a silane coupling agent, an amount of water sufficient to hydrolyze the silane coupling agent, a curative comprising a primary aromatic amine, and at least one non-water carrier solvent.

15. The method of embodiment 14, further comprising processing the corrosion inhibitor within the particulate dispersion to reduce the size of the corrosion inhibitor to a median primary particle size of from 0.1 micrometers to 100 micrometers.

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight.

TABLE 1
Materials

| Designation | Description | Source |
|---|---|---|
| Acetone | Acetone | Sigma Aldrich, St. Louis, |
| | | MO. United States |
| AF-163-2 | A structural adhesive film, available under | 3M Company, St. |
| | the trade designation” SCOTCH-WELD | Paul, MN. United States |
| | Structural Adhesive Film AF-163-2K”, | |
| | 0.06 weight | |
| BAPP | 2,2-bis-[4-(4-aminophenoxy)- | TCI America, Portland, |
| | phenyl]propane | OR. United States |
| B2G 03 | An aqueous additive pigment available under | Clariant AG, Muttenz, |
| | the designation Hostaperm Blue B2G 03 | Switzerland |
| CG-1400 | Dicyandiamide, available under the trade | Evonik Corporation, Allentown, |
| | designation “AMICURE CG-1400” | PA. United States |
| CG 500 | An aqueous binder-free pigment available | Clariant AG, Muttenz, |
| | under the designation Colanyl ® Green CG 500 | Switzerland |
| DAA | Diacetone alcohol | Sigma Aldrich, St. Louis, |
| | | MO. United States |
| DC-29 | A leveling agent available under the trade | Dow Inc., Midland, |
| | designation “DOW CORNING 29” | MI. United States |
| EPON 1007F | A solid epoxy resin available under the | Hexion Inc., Columbus, |
| | trade designation “EPON Resin 1007F” | OH. United States |
| EPON SU-8 | A polymeric solid epoxy novolac resin | Hexion Inc., |
| | having an average epoxide group | Columbus, OH. |
| | functionality of approximately eight | United States |
| | available under the trade designation | |
| | “EPON Resin SU-8” | |
| MEK | Methyl ethyl ketone | VWR International, Randor, |
| | | PA. United States |
| OAKITE 165 | A caustic wash solution available under | Chemetall GmbH, |
| | the trade designation “OAKITE 165” | Frankfurt, Germany |
| PGME | Propylene glycol methyl ether | VWR International, Randor, |
| | | PA. United States |
| PY 307-1 | Polyfunctional epoxidized phenol novolac | Huntsman Corporation, The |
| | resin available under the trade designation | Woodlands, TX. |
| | “ARALDITE PY 307-1” | United States |
| SAPP | A pigment grade strontium aluminum | Heubach GmbH, |
| | polyphosphate corrosion inhibitor | Langelsheim, |
| | available under the trade designation | Germany |
| | “HEUCOPHOS SAPP” | |
| TDI | A micronized grade of an aromatic | Evonik Corporation, |
| | substituted urea available under the trade | Allentown, PA. |
| | designation “Amicure UR-2T” | United States |
| Wetlink 78 | (3-glycidyloxypropyl)methyldiethoxy- | Hexion Inc., Columbus, |
| | silane | OH. United States |
| Z-6040 | 3-Glycioxypropyl Trimethoxysilane | Dow Chemical |
| | coupling agent available under the | Company, Midland, |
| | designation Z-6040 Silane | MI. United States |
| ZPA | Zinc aluminum orthophosphate corrosion | Heubach GmbH, |
| | inhibitor available under the trade | Langelsheim, |
| | designation “HEUCOPHOS ZPA” | Germany |

Test Methods

Grade 2024-T3 bare aluminum panels were obtained from Erickson Metals of Minnesota, Inc., Coon Rapids, Minn. Prior to bonding with structural adhesive, the panels were subjected to the following surface preparation process:

### Panel Preparation

### FPL Etched and Phosphoric Acid Anodized Aluminum Substrates

A bare aluminum panel was soaked in OAKITE 165 caustic wash solution for ten minutes at 85° C. (185° F.). The panel was then immersed in tap water for ten minutes at 21° C. (69.8° F.), followed by a continuous spray rinsing with tap water for approximately three minutes. The panel was then immersed in a Forest Products Laboratory (FPL) etch solution for ten minutes at 66° C. (151° F.), after which the panel was spray rinsed with water for approximately three minutes at 21° C. 69.8° F.), allowed to drip dry for another ten minutes, then dried in an oven for thirty minutes at 54° C. The etched panel was then anodized in a bath of 85% percent phosphoric acid at 22.2° C. (72° F.) for approximately twenty-five minutes at a voltage of 15 volts and a maximum current of 100 amps, rinsed with water for approximately three minutes at 21° C. (69.8° F.), allowed to drip dry for another ten minutes, then dried in an oven for ten minutes at 66° C. (151° F.). Within 24 hours of being anodized, the aluminum panel was primed with a primer composition as described in the following examples. The dried primer thickness was between 0.1-0.4 mils (2.5-10.2 micrometers (μm).

### Corrosion Protection Testing

Tests were conducted with 152 cm×152 cm (6 inches×6 inches) 2024-T3 primed panels exposed to a salt spray environment per the methods described in ASTM B-117. Exposure was conducted for 1000 hours in the salt spray chamber.

### Floating Roller Peel (FRP) Strength Test for Adhesive Film

Primed panels of 2024-T3 bare aluminum measuring 20.3 cm×7.6cm×0.16 cm (8.0 inches×3.0 inches×0.063 inches), and 25.4 cm×7.6 cm×0.064 cm (10 inches×3 inches×0.025 inch), were prepared for testing as described above in “FPL Etched and Phosphoric Acid Anodized Aluminum Substrates”. After removing the liner from one side, the AF-163-2 was applied by hand using a small rubber roller in such a manner as to exclude entrapped air and insure intimate contact between the exposed adhesive and the test panel substrate. The primed panels were bonded together and cured in an autoclave (refer to Adhesive Cure Cycle method defined below), then evaluated for floating roller peel strength in accordance with ASTM D-3167-76 with the following modification. Six samples were tested at three specific primer thicknesses for each example or comparative example and the average value (in N/25 mm) was reported. Test strips measuring 1.27 cm (0.5 inches) wide were cut along the lengthwise direction of the bonded aluminum panels. A tensile testing machine operated at a rate of 30.5 cm/minute (6 inches/minute) at 21.2° C. (70° F.) was used to peel the thinner substrate from the thicker one and the results normalized to a width of 2.54 cm (1 inch). Test panels were prepared and evaluated (one for each example).

### AF-163-2 Curing Instructions

Each AF-163-2 sample was vacuum bagged to a pressure of approximately 94.8 kPa (28 inches mercury) in an autoclave, model number “ECONOCLAVE 3×5”, obtained from ASC Process Systems of Sylmar, Calif. United States. Autoclave pressure was increased to 310.3 kPa (45 psi), during which the vacuum bag was vented to the atmosphere once the autoclave pressure surpassed 103.4 kPa (15 psi). Autoclave temperature was then increased at a rate of 2.5° C. (4.5° F.) per minute to 121.1° C. (250° F.). After reaching the set point the sample was held for 60 minutes at this temperature, then cooled at a rate of 2.8° C. (5.0° F.) per minute to 22.2° C. (72° F.) before releasing the pressure.

### Preparatory Example 1 (PE1)

A pigment pre-dispersion in epoxy was prepared as follows. 41.75 grams of SAPP and 10.42 grams of ZPA were blended with 47.71 grams of PY 307-1 and 0.58 grams B2G 03 and 2.31 grams of CG 500 by means of a high-speed mixer operating at 2,200 rpm for approximately 2-3 minutes at 25° C. (77° C.).

### Preparatory Example 2 (PE2)

A pigment pre-dispersion in water was prepared as follows. 21.87 grams of SAPP and 5.45 grams of ZPA were blended with 40.99 grams of deionized (DI) water and 0.3 grams B2G 03 and 1.2 grams of CG 500 by means of a high-speed mixer operating at 2,200 rpm for approximately 2-3 minutes at 25° C. (77° C.). While adding the inhibitors into water, noticeable amount of gassing coming out.

### Comparative Examples 1-3 (CE1-CE3) and Examples 1-3 (EX1-EX3)

Compositions were prepared by dispersing the materials identified in Table 2.

TABLE 2
Primer Compositions (grams)

| Material | CE1 | CE2 | CE3 | EX1 | EX2 | EX3 |
|---|---|---|---|---|---|---|
| EPON 1007F | 5.53 | 5.21 | 5.05 | 5.05 | 5.05 | 5.05 |
| EPON SU-8 | 0.60 | 0.57 | 0.55 | 0.55 | 0.55 | 0.55 |
| PY 307-1 | 2.02 | 0.0 | 1.84 | 0.0 | 0.0 | 0.0 |
| DC-29 | 0.01 | 0.01 | 0.01 | 0.01 | 0.01 | 0.01 |
| Z-6040 | 0.18 | 0.17 | 0.0 | 0.16 | 0.16 | 0.0 |
| TDI | 0.71 | 0.67 | 0.65 | 0.65 | 0.65 | 0.65 |
| MEK | 51.22 | 53.60 | 52.01 | 52.01 | 52.01 | 52.01 |
| BAPP | 1.98 | 1.87 | 1.81 | 1.81 | 1.81 | 1.81 |
| Acetone | 5.69 | 8.93 | 8.67 | 8.67 | 8.67 | 8.67 |
| DAA | 16.26 | 15.31 | 14.86 | 14.86 | 14.86 | 14.86 |
| PGME | 10.16 | 9.57 | 9.29 | 9.29 | 9.29 | 9.29 |
| PE1 | 0.0 | 4.09 | 0.0 | 3.97 | 3.97 | 3.98 |
| PE2 | 5.68 | 0.0 | 0.0 | 0.0 | 0.0 | 0.0 |
| DI Water | 0.0 | 0.0 | 2.97 | 2.97 | 2.97 | 2.97 |
| Wetlink 78 | 0.0 | 0.0 | 0.16 | 0.0 | 0.0 | 0.16 |
| ZPA | 0.0 | 0.0 | 0.40 | 0.0 | 0.0 | 0.0 |
| SAPP | 0.0 | 0.0 | 1.61 | 0.0 | 0.0 | 0.0 |
| B2G 03 | 0.0 | 0.0 | 0.02 | 0.0 | 0.0 | 0.0 |
| CG 500 | 0.0 | 0.0 | 0.09 | 0.0 | 0.0 | 0.0 |

### Comparative Example 1 (CE1)

The quantities designated in Table 2 of EPON 1007F, SU-8, PY 307-1, DC-29, and Z-6040 were added to a 3.78 Liter (L) mixing bowl. Next, the quantities of MEK, Acetone, DAA, and PGME were added to the mixing bowl followed by TDI and BAPP. The bowl was placed in a mixer and the materials were (250-300 rpm) mixed for 30-40 minutes. While the contents of the bowl were still being mixed, a quantity of PE2 (specified in Table 1) was added to the bowl and the primer composition was mixed for another 15-30 minutes.

### Comparative Example 2 (CE2)

Quantities designated in Table 2 were added to a 3.78 L bowl as described in Comparative Example 1 except that while the contents of the bowl were still being mixed, a quantity of PE1 (specified in Table 1) was added to the bowl and the primer composition was mixed for another 15-30 minutes,

### Comparative Example 3 (CE3)

The quantities designated in Table 2 of EPON 1007F, SU-8, PY 307-1, DC-29, Wetlink 78, MEK, Acetone, DAA, PGME, TDI and BAPP were added to a 3.78 Liter (L) mixing bowl. The bowl was placed in a mixer and the materials were (200-250 rpm) mixed for 30-40 minutes. While the contents of the bowl were still being mixed, a quantity of DI water (specified in Table 1) was added to the bowl and the primer composition was mixed for another 15-30 minutes. Once thoroughly mixed, quantities of ZPA, SAAP, B2G 03, and CG 500 (specified in Table 1) were added to the composition and mixed for 30-45 minutes.

### Example 1 (EX1)

Quantities designated in Table 2 were added to a 3.78 L bowl as described in Comparative Example 1 except that while the contents of the bowl were still being mixed, a quantity of PE1 (specified in Table 1) was added to the bowl and the primer composition was mixed for another 15-30 minutes. Once thoroughly mixed, a quantity of DI water (specified in Table 1) was added to the composition and mixed for 15-30 minutes.

### Example 2 (EX2)

Quantities designated in Table 2 were added to a 3.78 L bowl as described in Comparative Example 1 except that while the contents of the bowl were still being mixed, a quantity of DI water (specified in Table 1) was added and the primer composition was mixed for another 15-30 minutes. Once thoroughly mixed, a quantity of PE1 (specified in Table 1) was added to the composition and mixed for 15-30 minutes.

### Example 3 (EX3)

Quantities designated in Table 2 were added to a 3.78 L bowl and mixed as described in Example 1 except that Wetlink 78 was substituted for Z-6040.

Samples were agitated by hand in a transparent glass bottle and the inhibitor settling speed and agglomeration were visually observed. Primed Aluminum panels were subjected to corrosion testing. Results are represented in Table 3.

TABLE 3
Inhibitor Settlement, Agglomeration,
and Corrosion Resistant Test Results

| | Settlement | Inhibitor | Corrosion |
|---|---|---|---|
| Example | Speed | Agglomeration | Test |
| CE1 | Medium | No | Pass |
| CE2 | Low | No | Pass |
| EX1 | Low | No | Pass |
| EX2 | Low | No | Pass |
| EX3 | Low | No | Pass |
| CE3 | Fast | Yes | No |

The primers composition samples were sprayed on the aluminum panels and cured. The primed and cured aluminum samples were then bonded with AF 163-2K film adhesive according to the AF-163-2 curing instructions. The samples (excluding CE3) underwent FRP testing at room temperature (RT) and −55° C. (−67° F.). The results of FRP testing at room temperature (RT) and −55° C. are represented in Tables 4 and 5.

TABLE 4
FRP Test Results at RT

| | Primer | FRP | FRP Standard |
|---|---|---|---|
| | Thickness | Average | Deviation |
| | (μm) | (N/25 mm) | (N/25 mm) |
| CE1 | 3.81 | 321 | 9.5 |
| CE1 | 5.84 | 301 | 8.6 |
| CE1 | 9.14 | 279 | 23.0 |
| CE2 | 3.05 | 322 | 11.0 |
| CE2 | 3.81 | 313 | 9.5 |
| CE2 | 5.59 | 238 | 28.0 |
| EX1 | 2.03 | 323 | 23.0 |
| EX1 | 4.06 | 335 | 25.0 |
| EX1 | 7.37 | 328 | 29.0 |
| EX2 | 1.27 | 352 | 21.0 |
| EX2 | 3.81 | 359 | 8.0 |
| EX2 | 6.10 | 317 | 17.0 |
| EX3 | 2.03 | 339 | 14.0 |
| EX3 | 3.81 | 323 | 18.0 |
| EX3 | 7.87 | 311 | 18.0 |

TABLE 5
FRP Test Results at −55° C.

| | Primer | FRP | FRP Standard |
|---|---|---|---|
| | Thickness | Average | Deviation |
| Example | (μm) | (N/25 mm) | (N/25 mm) |
| CE1 | 0.15 | 294 | 13.0 |
| CE1 | 0.23 | 163 | 20.0 |
| CE1 | 0.36 | 91 | 18.0 |
| CE2 | 0.12 | 300 | 11.7 |
| CE2 | 0.15 | 108 | 18.0 |
| CE2 | 0.22 | 86 | 20.0 |
| EX1 | 0.05 | 321 | 9.3 |
| EX1 | 0.15 | 336 | 11.0 |
| EX1 | 0.24 | 251 | 54.0 |
| EX2 | 0.08 | 339 | 11.7 |
| EX2 | 0.16 | 323 | 5.2 |
| EX2 | 0.29 | 140 | 63.0 |
| EX3 | 0.08 | 338 | 6.8 |
| EX3 | 0.15 | 294 | 25.0 |
| EX3 | 0.31 | 180 | 66.0 |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A one-part primer composition comprising:
a first epoxy resin that is a liquid under ambient conditions;
a particulate corrosion inhibitor present in an amount of from 5 wt % to 30 wt % relative to the overall weight of the composition excluding carrier solvents and water, wherein the particulate corrosion inhibitor has a median primary particle size of from 0.5 micrometers to 10 micrometers;
a curative comprising a primary aromatic amine;
a silane coupling agent;
a carrier solvent; and
water homogeneously mixed with the carrier solvent and present in an amount sufficient to hydrolyze the silane coupling agent while preserving solubility of the first epoxy resin and curative in the carrier solvent/water mixture.

2. The composition of claim 1, wherein the carrier solvent comprises one or more of tetrahydrofuran, methyl ethyl ketone, diacetone alcohol, and a glycol monoether.

3. The composition claims 1, wherein the first epoxy resin comprises a diglycidyl ether of bisphenol A, bisphenol F, or bisphenol S; a phenolic or cresolic novolac resin; N,N,N′, N′-tetrakis(glycidyl)-4,4-diaminodiphenyl methane; N,N,O-tris(glycidyl)-4-aminophenol; glycidylether of dihydroxy-naphthalene or phenolated dicyclopentadiene; aliphatic diglycidyl ethers or blends of two or more low viscosity aliphatic glycidyl or diglycidyl ethers.

4. The composition of claim 1, wherein the particulate corrosion inhibitor comprises one or more of: strontium aluminum polyphosphate hydrate, zinc phosphate, zinc molybdate, and zinc aluminum polyphosphate hydrate.

5. The composition of claim 1, wherein the particulate corrosion inhibitor has a median primary particle size of from 0.1 micrometers to 100 micrometers.

6. The composition of claim 1, further comprising a second epoxy resin that is a solid under ambient conditions, the second epoxy resin comprises a novolac epoxy resin.

7. The composition of claim 6, wherein the second epoxy resin is present in an amount of from 1 wt % to 30 wt % relative to the overall weight of the composition excluding carrier solvents and water.

8. The composition of claim 1, further comprising a third epoxy resin that is a solid under ambient conditions, the third epoxy resin comprising a bisphenol A extended solid epoxy resin.

9. The composition of claim 8, wherein the third epoxy resin is present in an amount of from 15 wt % to 75 wt % relative to the overall weight of the composition excluding carrier solvents and water.

10. The composition of claim 1, wherein the primary aromatic amine comprises one or more of 4,4′-diaminodiphenylmethane, 2,2-bis(4-[4-aminophenoxy]phenyl)propane, 3,3′- and 4,4′-diaminodiphenylsulfone, 3,3′- and 4,4′-diaminodiphenyloxide, 3,3- and 4,4′-diaminodiphenyloxide, 3,3′- and 4,4′-diaminodiphenylsulfide, 3,3′- and 4,4′-diaminodiphenylketone, and 4,4′-[1,4-phenylene(1-methylethylidene)]-bis(benzeneamine).

11. The composition of claim 1, wherein the water is present in an amount of from 0.1 wt % to 20 wt % relative to the overall weight of the composition.

12. The composition of claim 1, wherein the silane coupling agent comprises an epoxy silane having either the formula: 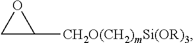
wherein m ranges from 1 to 6, and each R¹ is H or an alkyl group of 1 to 10 carbon atoms, or the formula:

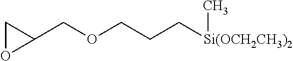

13. The composition of claim 1, wherein the epoxy resin has a viscosity of from 50 centipoise to 1,000,000 centipoise under ambient conditions.

14. A method of making a one-part primer composition, the method comprising the steps of:
dispersing a particulate corrosion inhibitor in a first epoxy resin having a viscosity of from 50 centipoise to 1,000,000 centipoise under ambient conditions to provide a particulate dispersion;
mixing the particulate dispersion with a silane coupling agent, an amount of water sufficient to hydrolyze the silane coupling agent, a curative comprising a primary aromatic amine, and at least one non-water carrier solvent.

15. The method of claim 14, further comprising processing the corrosion inhibitor within the particulate dispersion to reduce the size of the corrosion inhibitor to a median primary particle size of from 0.1 micrometers to 100 micrometers.
